(19) United States
(12) Patent Application Publication
(10) Pub. No.: US 2019/0371186 A1
(43) Pub. Date: Dec. 5, 2019

(54) DETERMINING METHOD OF A CONTINUOUS FLIGHT PATH OF AN AIRPLANE, ASSOCIATED COMPUTER PRODUCT PROGRAM AND SYSTEM

(71) Applicant: THALES, Courbevoie (FR)

(72) Inventors: François HOOFD, Toulouse (FR); Vincent Savarit, Toulouse (FR)

(21) Appl. No.: 16/431,146

(22) Filed: Jun. 4, 2019

(30) Foreign Application Priority Data
Jun. 5, 2018 (FR) 18 00565

(51) Int. Cl. G08G 5/00; G05D 1/02

(52) U.S. Cl. CPC G08G 5/0039; G05D 1/0202; G08G 5/0021; G08G 5/0034

(57) ABSTRACT

According to the method, the path is built from a flight plan defining a plurality of successive segments of this path, called legs. The method includes a first step for adapting a distance to be flown over the manual leg in a selected manner, as a function of data introduced by the pilot, or automatically, as a function of the leg following the manual leg such that the constraint of this following leg can be respected and a second step for integration into the path of a termination point of the manual leg as a function of the distance to be flown over this manual and the construction of a modified segment of the path from this termination point.

The present invention relates to a method for determining a method of a continuous flight path.

The present invention also relates to an associated computer program product and system.

More specifically, the present invention falls within the field of flight management systems (FMS) at the level of determining the path in the sense of determining a transition between two elements of a flight plan.

In a manner known in itself, a flight plan is introduced by the crew into the FMS before each flight and makes it possible to build a path of the aircraft before this flight. The path thus obtained is made up of a plurality of successive segments commonly called “legs” in the state of the art.

Thus, each leg defines at least one constraint that must be respected during the flight of the aircraft over this leg. Such a constraint may for example have a particular geometry of the path between two successive points defined by the leg, and/or specific altitude and/or speed conditions at least at one of these points. The different types of legs as well as the rules for their sequencing are in particular defined by standard ARINC 424.

Most of these legs define a starting point and a termination point. Furthermore, the constraint or at least some of the constraints defined by such a leg can be comprised in one of these points. When the constraint of at least one of these points corresponds to a waypoint fixed in space, i.e., a waypoint geographically fixed in space, the corresponding leg is called fixed leg or non-floating leg. This is in particular the case of the “TF” leg (Track to a Fix leg) defining a curved path along the Earth's surface between two fixed points that are geographically known.

When a leg has no fixed point, the leg is called floating point. This is for example the case of the CA leg (Course to an Altitude leg) defining a specific journey to a specific altitude at the termination point. Indeed, in this case, the termination point of the leg is reached when the aircraft reaches the specified altitude independently of its geographical position.

At least some of the legs may not have a specified termination point. In standard ARINC 424, this in particular involves the “FM” leg (Fix to a Manual termination leg) and the VM leg (Heading to a Manual termination leg). These legs are called manual legs inasmuch as the exit of such a leg is defined manually by the pilot during the flight on this leg, for example following an instruction by the air traffic controller.

One can then see that the presence of manual legs on the path of the aircraft does not make it possible to build a continuous path of the aircraft to give the pilot a complete view and for example to calculate the necessary predictions to reach the aircraft's final destination.

To offset this problem, the state of the art proposes two solutions.

A first solution consists of assuming that each manual leg is always followed by a leg called IF (Initial Fix) defined by a single fixed point.

In this case, any floating leg following the manual leg is eliminated, any fixed leg terminating in a fixed point is replaced by an IF leg in the termination point of this leg and any fixed leg starting with a fixed point is preceded by an IF leg in the start point of this leg.

In this solution, the path displayed to the pilot includes an infinite segment starting in the start point of the manual leg and the predictions are calculated from the direct distance between this start point and the IF leg then integrated into the path.

Thus, one can see that this solution does not make it possible to build a continuous path and does not give the pilot reliable predictions. Furthermore, it causes the pilot to lose at least some of the floating legs imposed by the procedure after the manual legs.

A second solution consists of using the FMS to calculate a continuous path by accounting for an inclusive and inalterable flight distance over the corresponding manual leg.

However, in this case, the pilot is dependent on the choice of the system, which has little chance of representing the path actually desired by the pilot and/or imposed by the air traffic controller.

The present invention aims to allow the construction of a continuous path with actual predictions while preserving all of the legs imposed by the procedure and allowing the pilot to influence the parameters of this path.

To that end, the invention relates to a method for determining a continuous path of an aircraft piloted by a pilot, the path being built from a flight plan defining a plurality of successive segments of this path, called legs;

each leg defining at least one constraint to be respected by the aircraft during the flight over this leg;

at least some of the legs further defining a termination point;

at least one of the legs, called manual leg, not having a termination point;

the method including:
a first step for adapting a distance to be flown over the manual leg in a selected manner, as a function of data introduced by the pilot, or automatically, as a function of the leg following the manual leg such that the constraint of this following leg can be respected;
a second step for integration into the path of a termination point of the manual leg as a function of the distance to be flown over this manual leg and the construction of a modified segment of the path from this termination point.

According to other advantageous aspects of the invention, the method comprises one or more of the following features, considered alone or according to all technically possible combinations:
the data introduced by the pilot comprise a distance to be flown over the manual leg, or a flight time and preferably, speed over this leg;
at least one of the legs, called non-floating leg, defines a fixed point in space;
when the leg following the manual leg is a non-floating leg, the distance to be flown over the manual leg is further adapted as a function of a connecting parameter defining the type of connection of the path of the aircraft with the following leg, the type of connection being chosen between an aligned type and a non-aligned type;
the data introduced by the pilot further comprise the connecting parameter;
when the distance to be flown on the manual leg is adapted automatically, the connecting parameter corresponds to the aligned type;
a third step for displaying the path of the aircraft, the modified segment of the path being displayed with a specific symbology;
a step for manual launching by the pilot of a new iteration of the method during the flight by the aircraft from its current position;
a step for automatic launching of a new iteration of the method during the flight by the aircraft from its current position, when the aircraft passes the termination point determined during the second step while continuing the flight along the manual leg.

The invention also relates to a computer program product including software instructions which, when implemented by computer equipment, carry out the method as previously defined.

The invention also relates to a system for computing a continuous path of an aircraft including technical means implementing the method as previously defined.

These features and advantages of the invention will appear upon reading the following description, provided solely as a non-limiting example, and done in reference to the appended drawings, in which:

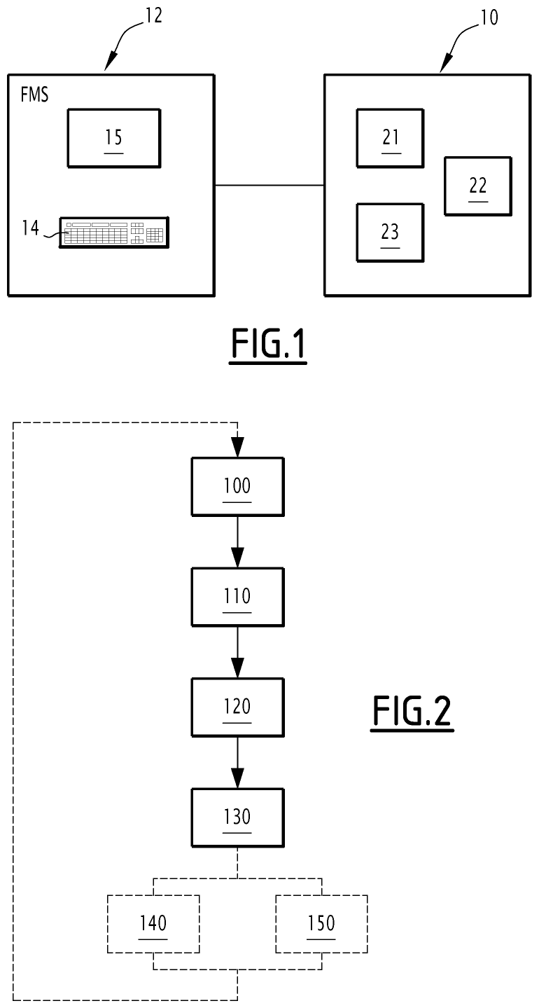

FIG. 1 is a schematic view of an system for computing a continuous path of an aircraft according to the invention;

FIG. 2 is a flowchart of a computing method according to the invention, the method being implemented by the system of FIG. 1 and in particular including a first step for adapting a distance to be flown over a manual leg, a second step for building a modified segment of the path and a third step for displaying this path;

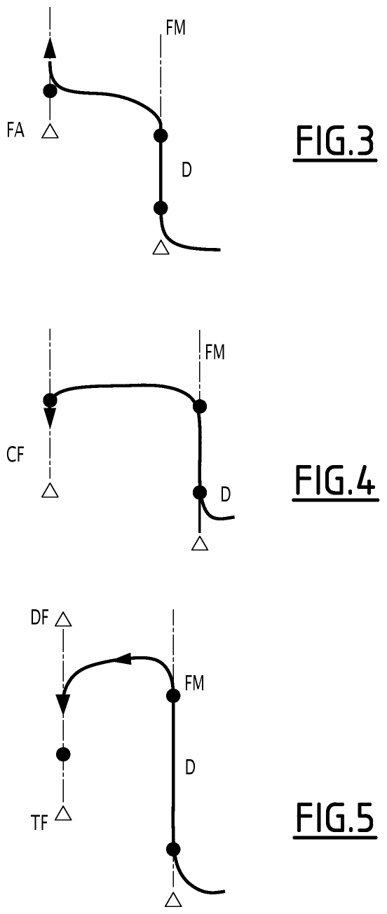

FIGS. 3 to 8 are schematic views illustrating the implementation of the first step of the method of FIG. 2; and

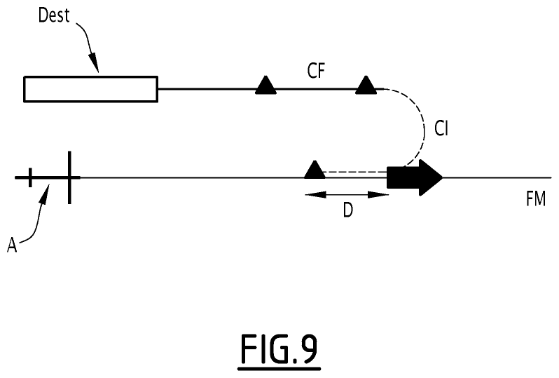

FIG. 9 is a schematic view illustrating the implementation of the third step of the method of FIG. 2.

The computing system 10 of FIG. 1 can be used to compute the continuous path of an aircraft.

An aircraft refers to any vehicle able to be piloted to fly in particular in the Earth's atmosphere, such as an airplane, in particular a commercial airplane, a helicopter, a drone, etc.

The aircraft can be piloted by a pilot from a cockpit of said aircraft or remotely.

The aircraft in particular has a flight management system, also known under the term “FMS”, which makes it possible to build a path of the aircraft from a flight plan introduced into this system by the pilot. To that end, the FMS is provided with a man-machine interface allowing the pilot to introduce necessary information into this system and to obtain a view of calculations done by this system, for example the path of the aircraft.

To that end, the man-machine interface of the FMS for example assumes the form of a suitable keyboard and a suitable display screen.

In the exemplary embodiment of FIG. 1, the computing system 10 is connected to the FMS, which is then designated general reference 12 in this FIG. 1.

The computing system 10 is on board the aircraft or is remote therefrom. In the latter case, this computing system 10 is connected to the FMS via remote digital data transmission means, known in themselves.

Furthermore, the computing system 10 is able to receive data introduced by the pilot into the FMS 12 via the keyboard 14 of this FMS 12 and to display results of its operation on the screen 15 of this FMS 12 or on any other screen of the cockpit of the aircraft, or on a remote screen.

According to the exemplary embodiment of FIG. 1, the computing system 10 assumes the form of a computer including an input module 21, a processing module 22 and an output module 23.

The input module 21 is then able to receive data from the FMS 12 and send them to the processing module 22.

The processing module 22 is able to process these data as will be explained hereinafter and to send a result of this processing to the output module 23.

Lastly, the output module 23 is able to send this result to the FMS 12 for example to display it on the screen 15.

Each of these modules 21, 22, 23 for example at least partially assumes the form of software executed by the computer forming the system 10 in particular using a processor and a memory that are provided to that end in this computer.

According to another exemplary embodiment (not illustrated), the computing system 10 is integrated into the FMS 12 or into any other existing computer of the aircraft or into a remote computer. In this case, the modules 21, 22, 23 at least partially assume the form of software executable by such a computer.

The computing method implemented by the computing system 10 will now be explained in reference to FIG. 2, showing a block diagram of its steps.

Initially, the path of the aircraft is computed by the FMS 12 from a flight plan introduced by the pilot, for example before the flight of the aircraft.

This path is formed from a plurality of segments called legs.

Each leg is for example defined according to standard ARINC 424.

As previously stated, each leg defines one or several constraints to be respected by the aircraft during the flight on that leg.

Furthermore, at least some of the legs define a starting point and/or a termination point. The constraint or at least some of the constraints defined by each leg can be in one of these points. Such a constraint may for example have a particular geometry of the path between two successive points defined by the leg, and/or specific altitude and/or speed conditions at least at one of these points.

When at least one of the points of a leg has a fixed geographical point, the leg is called fixed leg or non-floating leg. Thus, at least one constraint defined by a non-floating leg corresponds to the passage of the aircraft by the corresponding fixed point. In standard ARINC 424, this involves legs AF, CF, DF, FC, FD, FM, HF, HA, HM, PI, IF, RF and TF.

Otherwise, the leg is called floating point. In standard ARINC 424, this involves legs FA, CA, CD, CI, CR, VA, VD, VI, VM and VR.

Among these legs, legs FM and VM have no termination point. These legs are called manual legs.

Lastly, when at least one constraint of a leg defines a specific journey of the aircraft during the flight on this leg, the leg is called journey leg. Journey refers to a direction of the determined path of the aircraft relative to a reference direction that for example presents the north direction.

The method explained below is implemented for each manual leg present on the path initially computed by the FMS 12.

During an initial step 100 of the method, the pilot chooses how to implement the iteration in progress of the method between a selected approach and an automatic approach. The selected approach in particular means that the choice of at least certain parameters is made by the pilot.

This choice is in particular made just after the introduction of the flight plan into the FMS 12 or during the flight of the aircraft.

When the selected approach is used during the initial step 100, during a first step 110 of the method, the input module 21 of the system 10 invites the pilot to introduce, for example via the man-machine interface of the FMS 12, a distance to be flown along the manual leg.

In a variant, or as chosen by the pilot, the input module 21 invites the pilot to introduce a flight time as well as, optionally, an associated flight speed on the manual leg. In this case, the input module 21 determines, from these data, a distance to be flown on the manual leg.

According to one advantageous exemplary embodiment of the invention, during the same step 110, the input module 21 of the system 10 invites the pilot further to introduce a connecting parameter of the path with the leg following the manual leg in the case where this following leg is a non-floating leg.

In particular, the connecting parameter indicates the type of connection of the path with this following leg. This type is chosen between an aligned type and a non-aligned type.

The connection of the path with a non-floating leg is of the aligned type when the path is aligned with the journey defined by this leg before the fixed point defined by this leg in the case where this non-floating leg is also a journey leg or in the case where this non-floating leg does not define any journey, when the path is aligned with the journey defined by a journey leg following this non-floating leg.

Otherwise, the connection of the path with a non-floating leg is of the non-aligned type.

At the end of this step 110, the input module 21 sends the distance to be flown on the manual leg and optionally the type of connection with the following leg, to the processing module 22.

When the automatic approach is chosen during the initial step 100, during the first step 110 of the method, the processing module 22 automatically chooses the distance to be flown on the manual leg and the connecting parameter in the case where the leg following the manual leg is a non-floating leg.

In particular, during the automatic processing, the connecting parameter is advantageously considered to be of the aligned type.

The distance to be flown on the manual leg is chosen as a function of the following leg, such that the or each constraint of the following leg can be respected.

More specifically, when the following leg is a non-floating leg, the distance to be flown on the manual leg is chosen such that the path of the aircraft can pass through the or each fixed point defined by this leg and such that the type of connection of the path with the leg following the manual leg can be respected.

To that end, according to one embodiment, the processing module 22 travels each point of the manual leg from the starting point of that leg and determines whether a possible elementary path of the aircraft exists starting at that point, passing through the or each fixed point defined by the non-floating leg following the manual leg and respecting the imposed type of connection. When it involves the aligned type, such an elementary path can be determined by using one of the methods disclosed in document FR 3,019,284.

When a possible elementary path is determined, the processing module 22 stores this elementary path and determines the distance to be flown on the manual leg from the starting point of the manual leg up to a point at which the stored elementary path begins.

FIGS. 3 to 5 illustrate different construction scenarios of such an elementary path for all of the non-floating legs of standard ARINC 424 when this non-floating leg is preceded by a manual leg FM. The illustrations for a manual leg VM are substantially similar.

In particular, FIG. 3 shows an example sequence of a manual leg FM and a following leg FA. Indeed, as shown in this figure, it is still possible to adapt the distance D to be flown on the manual leg FM such that the path of the aircraft is aligned with the radial defined by the leg FA after it passes by the fixed point also defined by the leg FA. The same scheme can be applied when the leg following the manual leg FM is another manual leg FM.

FIG. 4 shows another example sequence of a manual leg FM and a following leg CF. Indeed, as shown in this figure, it is still possible to adapt the distance D to be flown on the manual leg FM such that the path of the aircraft is aligned with the radial defined by this leg CF before the termination point defined by this leg, with an angle smaller than X°, X being an adjustable value. In the figure, the value X is substantially equal to 90°. The same scheme can be applied when the leg following the manual leg FM is a leg FC or a leg FD.

FIG. 5 shows another example sequence of a manual leg FM and a following leg DF. Indeed, as shown in this figure, it is still possible to adapt the distance D to be flown on a leg FM such that the termination point defined by this leg DF can be reached by minimizing the angle formed by the arrival heading at this termination point and the journey defined by the leg following the leg DF (a leg TF in the example of the figure).

It should also be noted that the sequencing of a leg FM (or VM) is prohibited, according to the standard, toward the following non-floating legs: AF, HF, HA, HM, IF (only in the case of a leg FM), RF and TF.

When the following leg is a floating leg, the distance to be flown on the manual leg is chosen such that the or each constraint of this leg can be respected. Thus for example, when at least one constraint of this floating leg is defined in the termination point of this leg, the distance to be flown on the manual leg is chosen so as to obtain a nominal termination of this following leg.

To that end, according to one exemplary embodiment, the processing module 22 travels each point of the manual leg from the starting point of that leg and determines whether a possible elementary path exists built with the following leg starting at that point and respecting the or each constraint of this following leg.

When a possible elementary path is determined, the processing module 22 stores this elementary path and determines the distance to be flown on the manual leg from the starting point of the manual leg up to a point at which the stored elementary path begins.

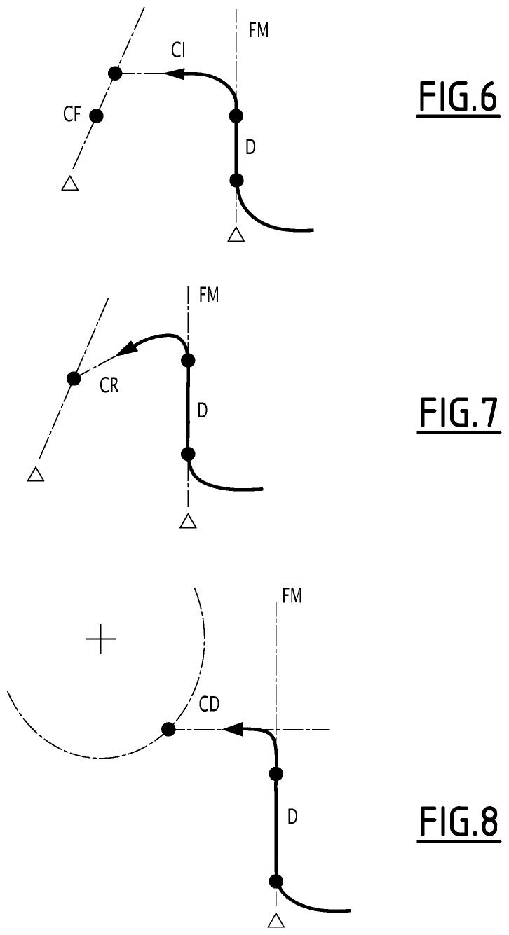

FIGS. 6 to 8 illustrate different construction scenarios of such an elementary path for all of the floating legs of standard ARINC 424 when this floating leg is preceded by a manual leg FM. The illustrations for a manual leg VM are substantially similar.

FIG. 6 shows another example sequence of a manual leg FM and a following leg CI. Indeed, as shown in this figure, it is still possible to adapt the distance D to be flown on the leg FM such that the leg CI nominally intercepts the leg following this leg CI (a leg CF, for example). The same scheme can be applied when the leg following the manual leg FM is a leg VI.

FIG. 7 shows an example sequence of a manual leg FM and a following leg CR. Indeed, as shown in this figure, it is still possible to adapt the distance D to be flown on the leg FM such that the journey defined by the leg CR intercepts the radial defined by this leg while making it possible to build a turn upon arrival. The same scheme can be applied when the leg following the manual leg FM is a leg VR.

FIG. 8 shows an example sequence of a manual leg FM and a following leg CD. Indeed, as shown in this figure, it is still possible to adapt the distance D to be flown on the leg FM such that the journey defined by the leg CR intercepts the arc specified by this leg while making it possible to build a turn upon arrival. The same scheme can be applied when the leg following the manual leg FM is a leg VR.

Lastly, when the leg following the manual leg FM is a leg CA or a leg VA or a leg VM, the termination point of the manual leg FM (and therefore the distance to be flown on that leg) can be chosen arbitrarily. According to one exemplary embodiment, this termination point is chosen such that the distance to be flown on the manual leg is equal to a predetermined value.

It should also be noted that the sequencing of a leg FM (or VM) is prohibited, according to the standard, with the following legs: HA, HM and PI.

During a second step 120 of the method, the processing module 22 incorporates, into the path of the aircraft, the termination point of the manual leg corresponding to the distance to be flown on that leg, determined during the preceding step.

Then, the processing module 22 builds a modified segment of the path following the integration of this termination point.

In particular, when the distance to be flown on the manual leg has been determined in a selected manner and in the case where the leg following the manual leg is a non-floating leg, the modified segment of the path connects the termination point of the manual leg with the fixed point defined by the non-floating leg while respecting the type of connection imposed by the pilot.

When the distance to be flown on the manual leg has been determined in a selected manner and in the case where the leg following the manual leg is a floating leg, the modified segment of the path builds the path of the floating leg from the termination point of the manual leg with the usual rules.

In the case where the imposed distance does not make it possible to build a continuous path, the pilot sees a path discontinuity and therefore adjusts the desired length or decides to let the system determine the correct value.

When the distance to be flown on the manual leg has been determined automatically, the modified segment of the path corresponds to the elementary path determined during the first step 110.

During a third step 130 of the method, the output module 23 acquires the segment of the path modified by the processing module 22 and sends it to the FMS 12 so that it can be displayed on the screen 15.

Thus, the path displayed on the screen 15 for example comprises the initial path computed by the FMS 12 and the segment modified by the computing system 10, for example superimposed with this initial path but using a specific symbology. This symbology can for example correspond to a specific display color.

One example of such a display is shown in FIG. 9.

In particular, this FIG. 9 illustrates an approach path of the aircraft A toward its destination Dest, in particular using legs FM, CI and CF.

In this figure, the distance D presents the distance to be flown on the leg FM determined during the first step 110.

Furthermore, the part in broken lines presents the modified segment of the path during the second step 120. The leg CI intercepts the following leg CF while remaining aligned with the journey defined by this leg CF.

The method according to the invention further optionally comprises a step 140 for manual launching by the pilot of a new iteration of the method, for example from the current position of the aircraft. This makes it possible to update the modified segment of the path for example in case of a change to the flight plan or when for example the pilot wishes to enter a new flight distance on the manual leg and/or a new type of connection, for example to cancel the data previously introduced.

The manual launching is done by the pilot for example from the man-machine interface of the FMS 12.

The method according to the invention further optionally comprises a step 150 for automatic launching of a new iteration of the method.

This launching is done by the processing module 22 from the current position of the aircraft, when for example it passes the termination point determined during the second step 120 by continuing flight on the manual leg.

One can then see that the invention has a certain number of advantages.

First, the invention makes it possible to keep all of the floating legs provided by the flight plan even when these legs are preceded by a manual leg.

The invention makes it possible to compute a precise path because it connects the airplane to the destination clearly and uniquely, and is suitable for the reality of the flight (via an adjustment to account for altitude and speed constraints—the text in parentheses is provided solely to aid comprehension), which reliabilizes predictions and guidance to the destination.

Lastly, the invention allows the pilot to control the path of the aircraft near the manual legs and therefore does not depend on the choice of the system.

1. A method for determining a continuous path of an aircraft piloted by a pilot, the path being built from a flight plan defining a plurality of successive segments of this path, called legs;
each leg defining at least one constraint to be respected by the aircraft during the flight over this leg;
at least some of the legs further defining a termination point;
at least one of the legs, called manual leg, not having a termination point;
the method including:
a first step for adapting a distance to be flown over the manual leg in a selected manner, as a function of data introduced by the pilot, or automatically, as a function of the leg following the manual leg such that the constraint of this following leg can be respected;
a second step for integration into the path of a termination point of the manual leg as a function of the distance to be flown over this manual leg and the construction of a modified segment of the path from this termination point.

2. The method according to claim 1, wherein the data introduced by the pilot comprise a distance to be flown over the manual leg, or a time.

3. The method according to claim 1, wherein the data introduced by the pilot comprise a distance to be flown over the manual leg, or a time and a flight speed on this leg.

4. The method according to claim 1, wherein:
at least one of the legs, called non-floating leg, defines a fixed point in space;
when the leg following the manual leg is a non-floating leg, the distance to be flown over the manual leg is further adapted as a function of a connecting parameter defining the type of connection of the path of the aircraft with the following leg, the type of connection being chosen between an aligned type and a non-aligned type.

5. The method according to claim 4, wherein the data introduced by the pilot further comprise the connecting parameter.

6. The method according to claim 4, wherein when the distance to be flown on the manual leg is adapted automatically, the connecting parameter corresponds to the aligned type.

7. The method according to claim 1, further comprising a third step for displaying the path of the aircraft, the modified segment of the path being displayed with a specific symbology.

8. The method according to claim 1, further comprising a step for manual launching by the pilot of a new iteration of the method during the flight by the aircraft from its current position.

9. The method according to claim 1, comprising a step for automatic launching of a new iteration of the method during the flight by the aircraft from its current position, when the aircraft passes the termination point determined during the second step while continuing the flight along the manual leg.

10. A computer program product comprising software instructions which, when implemented by a piece of computer equipment, carry out the method according to claim 1.

11. A system for determining a continuous path of an aircraft, the path being built from a flight plan defining a plurality of successive segments of this path, called legs;
each leg defining at least one constraint to be respected by the aircraft during the flight over this leg;
at least some of the legs further defining a termination point;
at least one of the legs, called manual leg, not having a termination point;
the computing system including:
means for adapting a distance to be flown over the manual leg in a selected manner, as a function of data introduced by the pilot, or automatically, as a function of the leg following the manual leg such that the constraint of this following leg can be respected;
means for integration into the path of a termination point of the manual leg as a function of the distance to be flown over this manual leg and the construction of a modified segment of the path from this termination point.
